(19) United States
(12) Patent Application Publication
(10) Pub. No.: US 2016/0004728 A1
(43) Pub. Date: Jan. 7, 2016

(54) METHOD, SYSTEM, AND COMPUTER PROGRAM PRODUCT FOR MANAGING BUSINESS CUSTOMER CONTACTS

(71) Applicant: III Holdings 1, LLC, Wilmington, DE (US)

(72) Inventors: Gregory J. BALET, New York, NY (US); David Y. CHOI, Ft. Lee, NJ (US); Young Choon LEE, Monroe, NJ (US); Jon William SAWYER, Elmwood Park, NJ (US); Danielle L. SMITH, New York, NY (US); Atul K. SRIVASTAVA, Edison, NJ (US); Michael A. VAPENIK, Berkley Hights, NJ (US)

(21) Appl. No.: 14/851,293

(22) Filed: Sep. 11, 2015

Related U.S. Application Data
(63) Continuation of application No. 11/677,906, filed on Feb. 22, 2007.

(51) Int. Cl. G06F 17/30

(52) U.S. Cl. CPC G06F 17/30292; G06F 17/30604

(57) ABSTRACT

In an enterprise where a database maintains multiple accounts for business customers, a method, system, and computer program product correctly links accounts which are associated with a common business. Business identification information from one or more external data sources is obtained and the format of the business identification data is standardized. Data records of business accounts are compared according to a plurality of rules for matching one business account to another. When two business accounts are found to match according to the business matching rules, a common identifier is applied to both business accounts to flag the two accounts as being associated with the same business entity. One or more hierarchy rules are applied to accounts associated with a common business, to establish a hierarchy among the accounts for purposes of marketing and other business communications.

### BACKGROUND OF THE INVENTION

1. Field of the Invention

The present invention generally relates to managing business customer information, and more particularly to linking business customer accounts within a database.

2. Related Art

Businesses and other institutional clients often have more than one account established through a particular enterprise, especially with a service-oriented enterprise such as a financial services enterprise or an insurance enterprise. In the case of an enterprise of the financial services industry, for example, a single business customer may have any combination of one or more bank accounts, multiples lines of credit, multiple business credit cards, and one or more investment accounts with the single financial enterprise. For an enterprise in the insurance business, a single business customer of the enterprise may have any combination of health insurance, property insurance, liability insurance, and other kinds of insurance protection as well.

In some cases, different business accounts may be associated with different business locations (and hence different addresses) which are all affiliated with the same business. In still other cases, various accounts may be listed with variations of the same address. Some different accounts of the same business may even use post office box addresses or other alternate addresses rather than direct mailing addresses, all to describe what is actually a single physical location of the business.

In addition to existing accounts, an enterprise may cull marketing data about other businesses from a variety of internal and external data sources. In turn, these data sources may have similar manifold data associated with individual businesses, e.g., different locations for the same business, different addresses for what is actually the same location, variations on a single address, etc.

As a result, during the process of contacting a business for marketing or other purposes, an enterprise may make redundant contacts, e.g., distributing marketing literature to multiple locations of the same business. If the same business location is listed in an enterprise database with two variations on the same address, or two variations on the same contact name, the same location or contact person may even be contacted twice by the enterprise. Equally problematic, an enterprise may contact these multiple channels of the same business with different or inconsistent information, such as different marketing offers related to the same product. These multiple contacts increase the cost for an enterprise of marketing to or otherwise contacting businesses, and further result in inconsistent contact approaches.

Further, a business may express preferences about how it is to be contacted. However, if the different locations or executives of the business are not recognized as actually belonging to the common business, these preferences may not be consistently respected by the enterprise as the enterprise contacts different locations, business units, or staff within the business.

Given the foregoing, what is needed then is a system, method, and computer program product for ensuring that multiple account listings for a common business are linked together, so that consistent contact and marketing policies may be established and implemented, and so that business customer preferences may be respected in all contacts with the business.

### BRIEF SUMMARY OF THE INVENTION

The present invention meets the above-identified needs by providing a method, system, and computer program product for linking business customer information. This method is referred to as the institutional customer linking and identification capability (i-CLIC) method.

In one embodiment of the invention, the i-CLIC method comprises collecting business account data from a plurality of internal and external data sources. An analysis is performed based on a plurality of business matching rules to determine which accounts are actually accounts of the same business. Linkages are then created between all accounts belonging to a single, unique business customer by assigning to the business accounts a shared, common identification number or similar identifier. Further rules may then be applied to determine a priority among the multiple accounts associated with the single, unique business.

Further embodiments, features, and advantages of the present invention, as well as the structure and operation of the various embodiments of the present invention, are described in detail below with reference to the accompanying drawings.

### BRIEF DESCRIPTION OF THE DRAWINGS/FIGURES

The features and advantages of the present invention will become more apparent from the detailed description set forth below when taken in conjunction with the drawings in which like reference numbers indicate identical or functionally similar elements. Additionally, the left-most digit or digits of a reference number identifies the drawing in which the reference number first appears.

FIG. 1 illustrates two exemplary successive data states for a set of business records, where all the business records are associated with a single location of a common business.

FIG. 2 illustrates two exemplary successive data states for a set of business records, where each business record is associated with a different location of a common business.

FIG. 3 is a flowchart illustrating an exemplary institutional customer linking and identification capability (i-CLIC) process according to one embodiment of the present invention.

FIG. 4 is a flowchart illustrating an exemplary i-CLIC process according to another embodiment of the present invention.

FIG. 5 is a block diagram of an exemplary computer system useful for implementing the present invention.

### DETAILED DESCRIPTION OF THE INVENTION

### I. Introduction

A method, system, and computer program product for linking business customer accounts, and specifically for linking business customer accounts that are all accounts of a common business, within a business or other organizational database maintained by an enterprise is described. It should be understood that while the method, system, and computer program product are described here in the context of managing records of businesses, business activities, and business customer and account databases implemented in an enterprise context, the method, system, and computer program product could as well be implemented and applied in other contexts as well.

For example, the method, system, and computer program product described herein could be used to link accounts of a non-commercial nature which are related to a common, unique organization described in a database implemented in a non-commercial and non-business context. Such organizations might include, for example and without limitation, governmental organizations, schools, charities or other non-profit organizations, or even religious organizations.

The present invention is now described in more detail herein in terms of an exemplary enterprise context, and typically in the context of a financial enterprise. This is for convenience only and is not intended to limit the application of the present invention. In fact, after reading the following description, it will be apparent to one skilled in the relevant art(s) how to implement the following invention in alternative embodiments, as indicated above. Thus, the description provided below is for purposes of illustration and explanation only, and should not be construed as limiting the scope of the invention. Rather, the scope of the invention is determined by the appended claims.

The terms “business”, “organization”, “consumer”, “customer”, “client”, “prospect”, and/or the plural form of these terms are used interchangeably throughout herein to refer to those entities capable of accessing, using, being affected by, being listed in the one or more databases of, purchasing the products of, being clients of, seeking the products and/or services of, being offered products and/or services of, and/or subscribing to or benefiting from the products and/or services of the representative enterprise unit, units, organization, or organizations which would implement and apply the method, system, and computer program product tool that the present invention provides for linking business customer information.

Furthermore, the terms “business”, “merchant”, and/or “organization”, may be used interchangeably with each other and shall mean any person, entity, distributor system, software and/or hardware that is a provider, broker and/or any other entity in the distribution chain of goods or services. For example, a merchant may be a grocery store, a retail store, a travel agency, a service provider, an on-line merchant, a financial institution or service provider, or the like. A business or organization as understood herein may include not only for-profit businesses, but also non-profit or not-for-profit organizations such as schools, and may even be construed to encompass governmental or semi-governmental agencies, including but not limited to the Post Office, law enforcement agencies, etc.

As the present invention relates to a business which, among other activities, manages a list or a database of other businesses, some ambiguity may arise from the frequent use of the term “business”. Therefore, for purposes of this document the term “enterprise” will be used to refer specifically and exclusively to a business or other organization which implements the present invention to manage a database of other businesses or organizations. All other references to “business” or “businesses” may be presumed to refer to companies and other organizations, apart from the enterprise, with whom the enterprise may have business relations, with whom the enterprise may seek business relationships, or which the enterprise tracks as part of a business-related database. No other special meaning, implication, or limitation should be drawn from the use of the term “enterprise”, except for its deliberate use as a means to distinguish a business which implements the present invention from other businesses which are listed and tracked in a database or similar listing of the enterprise.

It is to be understood, then, that the enterprise in question has customers which are typically business customers or other organizational or institutional customers, and that the enterprise uses the present invention to link internally maintained business accounts of its business or institutional customers.

An “account”, as used in this document, commonly refers to a set or collection of data which indicates transactions between a business customer and an enterprise which are typically bundled together under the name of a service of some kind, and/or a status or statuses of services which an enterprise may provide to a customer, and/or a set of one or more legal or financial obligations on the part of an enterprise towards the customer, and/or a set of one or more legal or financial obligations on the part of a customer towards an enterprise. For example, a loan account may record a business customer's credit line with an enterprise, as well as specific transactions wherein the customer has borrowed money against the loan account or paid back principle or interest on the account. An “account” may also be understood to refer more broadly to any kind of collection of data which an enterprise may maintain in relation to a business customer or other institutional customer associated with the enterprise.

An “account number”, as used herein, and as sometimes also referred to simply as an “account”, may include any device, code, number, letter, symbol, digital certificate, smart chip, digital signal, analog signal, biometric or other identifier/indicia suitably configured to allow a business or institutional customer to access, interact with or communicate with a financial transaction system or other transaction system of an enterprise. The account number may optionally be located on or associated with any financial transaction instrument (e.g., rewards, charge, credit, debit, prepaid, telephone, embossed, smart, magnetic stripe, bar code, transponder or radio frequency card). An account number may also refer to a similar identification value (e.g., a device, code, number, letter, symbol, digital certificate, smart chip, digital signal, analog signal, biometric or other identifier/indicia) which is used only internally by an enterprise as a means to identify a customer for purposes of in-house processing.

A customer account number may be, for example, a sixteen-digit credit card number. Each credit card issuer has its own numbering system, such as the fifteen-digit numbering system used by American Express Company of New York, N.Y. A merchant account number may be, for example, any number or alpha-numeric characters that identifies a particular merchant for purposes of card acceptance, account reconciliation, reporting and the like.

A customer account may be associated with a record in a database or other storage. In this document, such terms as “customer account”, “customer record”, “business account”, “business record”, and similar terms and the plurals thereof will be used interchangeably to designate a storage of account data pertaining to a business or other customer.

A “generation code”, sometimes called a “suffix”, is a suffix to a name, which may be a full word such as “Senior” or “Junior” or similar, or an abbreviated appellation such as “Sr.”, or “Jr.” or similar, or may be a numeric designation such as “the Second”, “the Third”, “2^{nd}”, “3^{rd}”, or similar, which indicates lineage within a family, and is generally considered to be part of a person's full name.

### II. Overview

At least two scenarios regarding business records exist. In the first scenario, a single business may be represented by business records showing multiple names and/or multiple addresses for the single business. In this case, all such records may be linked so that they are associated with a single common business. In the second scenario, a single business may be represented by records for different locations, reflecting the fact that the business may actually operate out of multiple locations. Here again all such records may be linked so that they are all associated with the single common business.

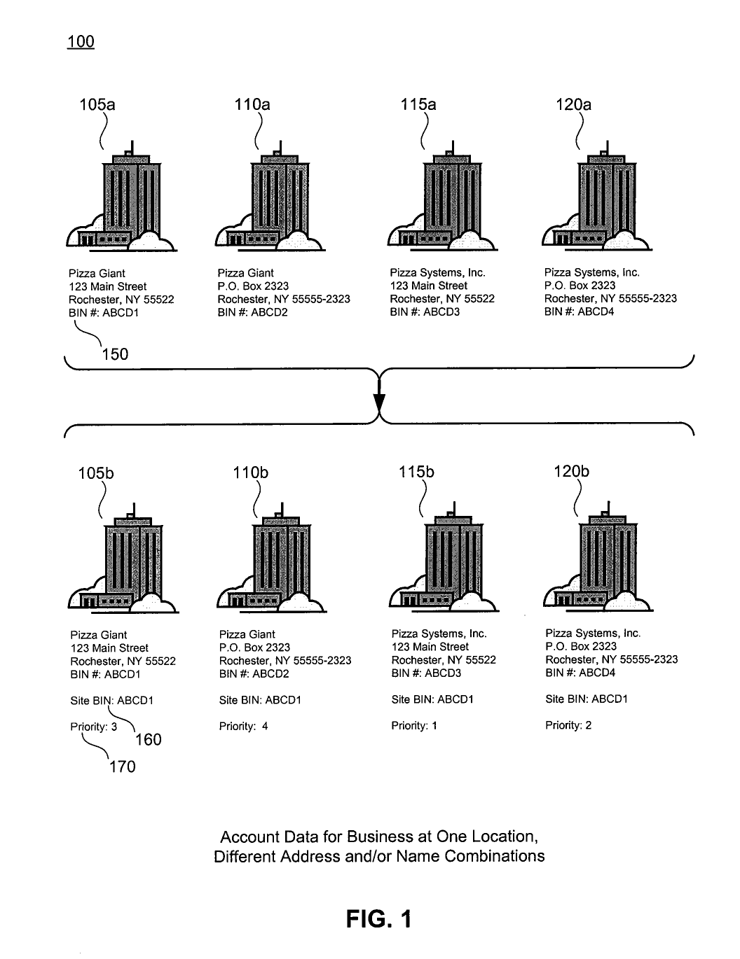

FIG. 1 is an illustration 100 of the first scenario referred to above. Two exemplary successive data states for a set of business records are illustrated, where all the business records are associated with a single location (e.g., a single office building) of a common business. In the initial data state the business records are not linked and are not prioritized, while in the successive data state the business records are linked and are prioritized.

A single business operating out of a single location is represented in the initial state in a database by four different records 105a, 110a, 115a, and 120a. The records 105a, 110a, 115a, 120a may reflect different business names, such as a formal name which may for example be used for legal purposes, and a common name which may for example be used for marketing or other purposes. In the example illustrated, records 105a, 110a reflect the business name “Pizza Giant”, while records 115a, 120a reflect the business name “Pizza Systems, Inc.”.

Similarly, records 105a, 115a reflect a street address of the business, namely “123 Main Street, Rochester, N.Y. 55522”, while records 110a, 120a reflect a P.O. Box address, namely “P.O. Box 2323, Rochester, N.Y. 55555-2323”. As a result of the various combinations of business names and addresses, the four records appear to reflect four distinct businesses. Note that each business record has a unique business identification number (“BIN #”) 150 which identifies the record, but which generally does not serve to associate the four records as being associated with a single common business.

As described further below, the four records may be modified as shown in the successive data state by the records 105b, 110b, 115b, and 120b. Note that each of business records 105b, 110b, 115b, 120b correspond to the previously discussed, original records 105a, 110a, 115a, 120a, respectively, and may be viewed as modified forms of the original records.

In one embodiment of the present invention, the modification may occur in place, in the sense that records 105a, 110a, 115a, 120a may be preserved in an original database, and modified within that database to produce business records 105b, 110b, 115b, 120b. In an alternative embodiment, business records 105a, 110a, 115a, 120a may be copied to an alternative storage (including, for example and without limitation, another database, a file on disk, random access memory, etc.), and the modifications that are made to generate modified business records 105b, 110b, 115b, 120b may be applied to the copied records.

After the modifications are made business records 105b, 110b, 115b, 120b retain the same address and name information as before. However, business records 105b, 110b, 115b, 120b now contain an additional data field “Site BIN” 160 (for “Site Business Identification Number”).

In one embodiment of the present invention, the Site BIN field 160 may be present in the original data records 105a, 110a, 115a, 120a, but have no value or a null value; in an alternative embodiment, the Site BIN field 160 may be added to the data records in the process of creating business records 105b, 110b, 115b, 120b. In either case, Site BIN field 160 contains a common value (“ABCD1”, in the example illustrated), which is common to all four data records. This common value flags or identifies all four data records as being associated with a common business.

In one embodiment of the present invention, the common value of the Site BIN field 160 may be the same as one of the values of the BIN field 150 for one of the original business data records 105a, 110a, 115a, 120a. In this case, the Site BIN field 160 may serve to flag a primary or principle business account for the business, also referred to later herein as an “ultimate location”. In an alternative embodiment, the value used for the Site BIN field 160 may be different from any of the values assigned to the BIN fields 150 of the business records.

The four records may be further modified as shown by records 105b, 110b, 115b, and 120b. As will be discussed in detail further below, business records 105b, 110b, 115b, 120b may also now have an additional data field “Priority” 170.

In one embodiment of the present invention, the Priority field 170 may be present in the original data records 105a, 110a, 115a, 120a, but have no value or a null value; in an alternative embodiment, the Priority field 170 may be added to the data records in the process of creating business records 105b, 110b, 115b, 120b. In either case, Priority field 170 contains, for each business data record, a value (“1”, “2”, “3”, and “4”, in the example illustrated), which indicates a ranking or priority among the business contact records of the common business. In particular, the values in the priority field 170 may be used at a later time by a marketing process or other business communications process to determine which record or records indicate the appropriate contact channel(s) for the one common business associated with the records.

Persons skilled in the relevant arts will recognize that the particular format and content of the business data records illustrated in FIG. 1 is exemplary only. Other forms and content, including additional, fewer, or alternative data fields, or different labels or names for the data fields, or additional or alternative data structures, may be readily employed within the scope and spirit of the present invention. Similarly, the BIN, Site BIN, and Priority values illustrated are exemplary only; other identifiers and priority values, in other formats, may be employed within the scope and spirit of the present invention.

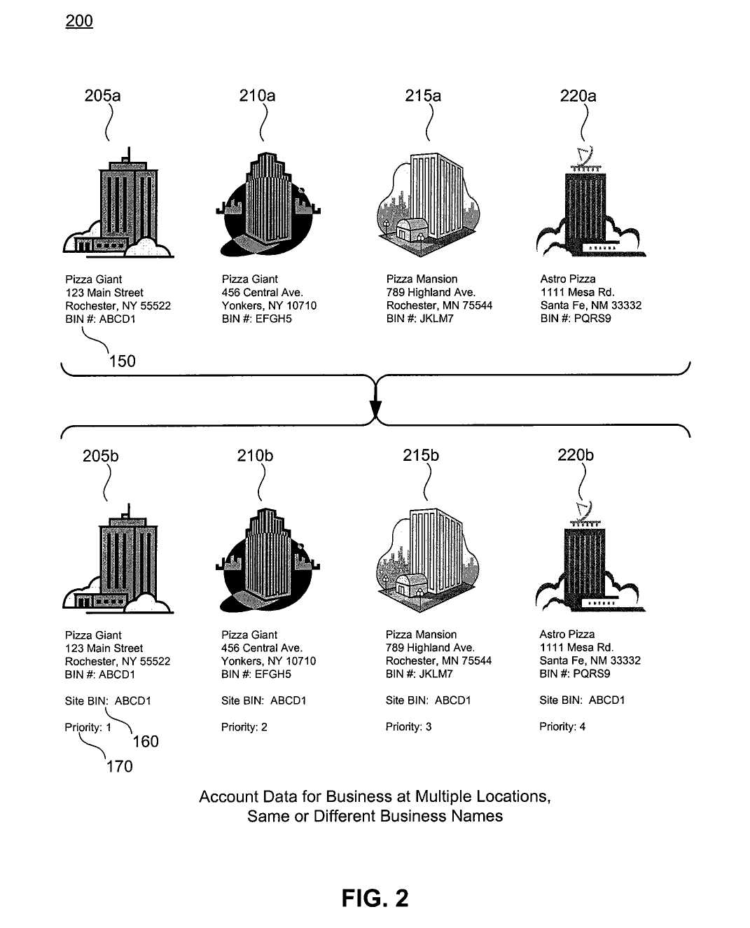

FIG. 2 provides an illustration 200 of the second scenario referred to above. Two exemplary successive data states for a set of business records are illustrated, where each business record is associated with a different location (e.g., different office building locations or different operating facility locations) of a common business. In the initial data state the business records are not linked and are not prioritized, while in the successive data state the business records are linked and are prioritized

A single business operating out of multiple locations is represented in a database by an initial data state of four different records 205a, 210a, 215a, and 220a. The records 205a, 210a, 215a, 220a will have different addresses for the different locations. In addition, some or all of records 205a, 210a, 215a, 220a may reflect different business names, such as a formal name which may for example be used by a corporate headquarters, and a common name which may for example be used for storefronts, franchises, outlets operating in different states or other markets, etc. In the example illustrated, records 205a, 210a reflect the business name “Pizza Giant”, while records 215a and 220a reflect the business names “Pizza Mansion” and “Astro Pizza”, respectively. Similarly, each of the four business records 205a, 210a, 215a, 220a have an address indicating a distinct operating location. As before, each business record has a unique BIN number 150 which identifies the record, but which generally does not serve to associate the four records as being associated with a single common business.

The four business records 205a, 210a, 215a, 220a reflect four separate operating locations of a common business. As described further below, the four records 205a, 210a, 215a, 220a may be modified to create a successive data state as shown by business data records 205b, 210b, 215b, and 220b. Note that each of business records 205b, 210b, 215b, 220b correspond to the previously discussed, initial records 205a, 210a, 215a, 220a, respectively, and may be viewed as modified forms of the original records.

In one embodiment of the present invention, the modification may occur in place, in the sense that records 205a, 210a, 215a, 220a may be preserved in an original database, and modified within that database to produce business records 205b, 210b, 215b, 220b. In an alternative embodiment, business records 205a, 210a, 215a, 220a may be copied to an alternative storage (including, for example and without limitation, another database, a file on disk, random access memory, etc.), and the modifications that are made to generate modified business records 205b, 210b, 215b, 220b may be applied to the copied records.

Business records 205b, 210b, 215b, 220b retain the same address and name information as before. However, business records 205b, 210b, 215b, 220b now contain an additional data field Site BIN 160. In one embodiment of the present invention, the Site BIN field 160 may be present in the original data records 205a, 210a, 215a, 220a, but have no value or a null value; in an alternative embodiment, the Site BIN field 160 may be added to the data records in the process of creating business records 205b, 210b, 215b, 220b. In either case, Site BIN field 160 contains a common value (“ABCD1”, in the example illustrated), which is common to all four data records. This common value identifies all four data records as being associated with a common business.

In one embodiment of the present invention, the common value of the Site BIN field 160 may be the same as one of the values of the BIN field 150 for one of the original business data records 205a, 210a, 215a, 220a. In this case, the Site BIN field 160 may serve to flag a primary or principle business account for the business, also referred to later herein as an “ultimate location”. In an alternative embodiment, the value used for the Site BIN field 160 may be different from any of the values assigned to the BIN fields 150 of the business records.

The four records may be further modified as shown by business data records 205b, 210b, 215b, and 220b. As will be discussed in detail further below, business records 205b, 210b, 215b, 220b may also now contain an additional data field “Priority” 170.

In one embodiment of the present invention, the Priority field 170 may be present in the original data records 205a, 210a, 215a, 220a, but have no value or a null value; in an alternative embodiment, the Priority field 170 may be added to the data records in the process of creating business records 205b, 210b, 215b, 220b. In either case, Priority field 170 contains, for each business data record, a value (“1”, “2”, “3”, and “4”, in the example illustrated), which indicates a ranking or priority among the business contact records of the common business. In particular, the values in the priority field 170 may be used at a later time by a marketing process or other business communications process to determine which record or records indicate the appropriate contact channel(s) for the one common business associated with the records.

In an embodiment of the present invention, each business account has only a single priority field, with a single priority value. In an alternative embodiment, each business account may have two or more priority fields, with each such field having a priority value. Such a plurality of priority fields may enable an enterprise to define one kind of priority for certain kinds of marketing or business communications purposes, a second kind of priority for certain other marketing or other business communications purposes, etc.

Persons skilled in the relevant arts will recognize that the particular format and content of the business data records illustrated is exemplary only. Other forms and content, including additional, fewer, or alternative data fields, or different labels or names for the data fields, or additional or alternative data structures, may be readily employed within the scope and spirit of the present invention. Similarly, the BIN, Site BIN, and Priority values illustrated are exemplary only; other identifiers and priority values, in other formats, may be employed within the scope and spirit of the present invention.

### III. Exemplary i-CLIC Method

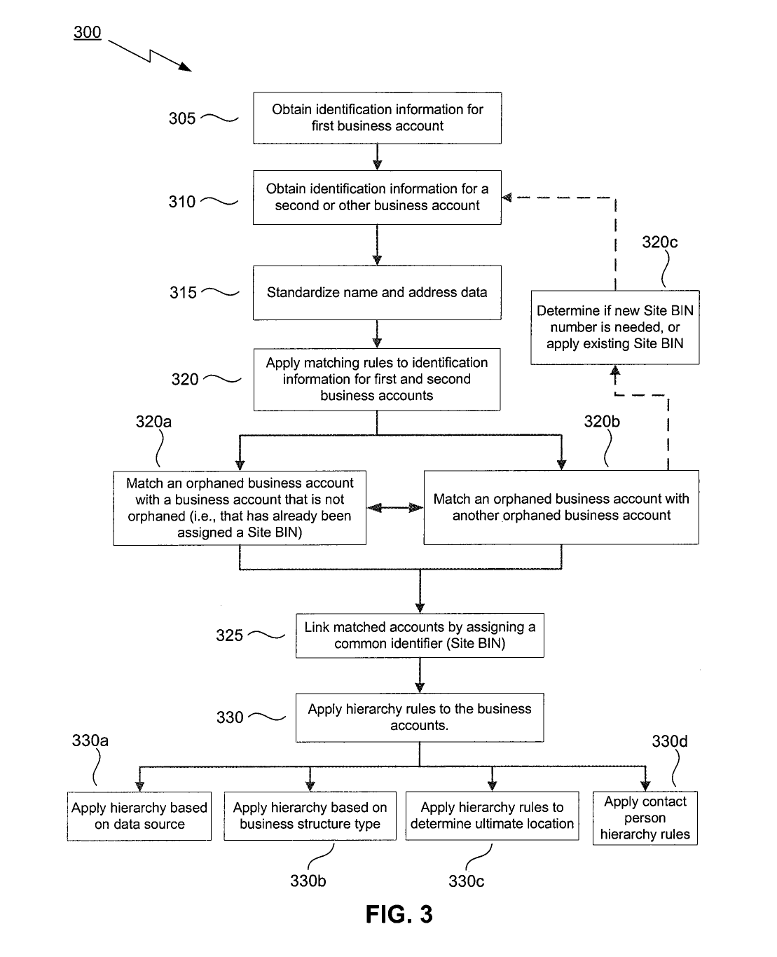

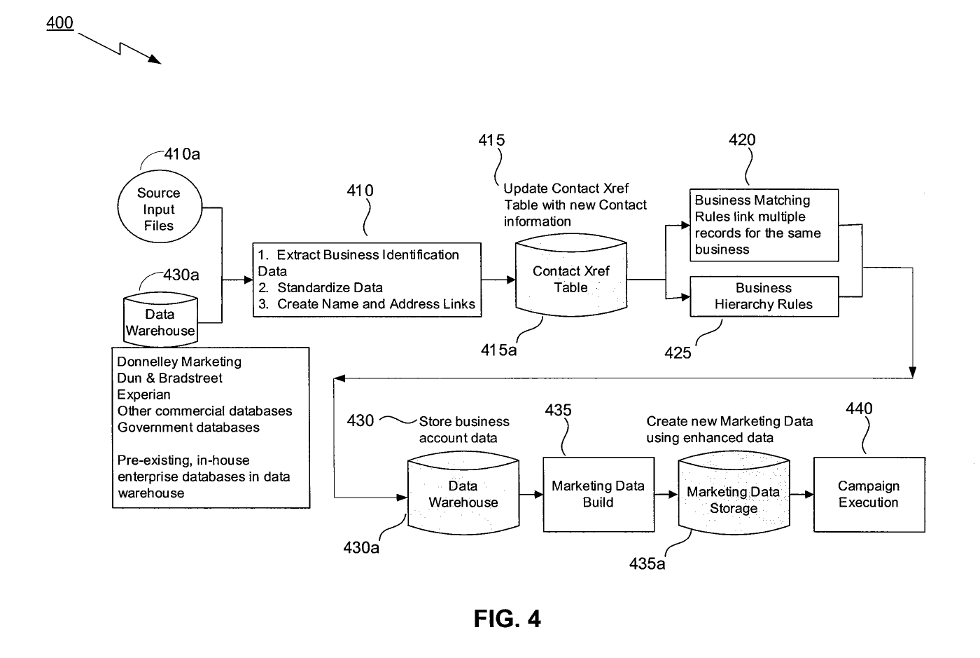

FIG. 3 is a flowchart illustrating an exemplary institutional customer linking and identification capability (i-CLIC) process 300 according to one embodiment of the present invention. The flowchart illustrates a method of processing specific business records, and may be viewed as a low-level, detailed view of an i-CLIC process. Method 300 is at the account level, and does not illustrate the interaction of method 300 with marketing or other business communications systems which may take advantage of the linked business accounts. Those interactions are presented in detail below, in conjunction with FIG. 4.

Preliminary to examining in detail the steps of method 300, some definitions are provided:
An orphaned business account is a business account for which a Site BIN value has not yet been assigned.
An assigned business account is a business account for which a Site BIN value has been assigned.

In steps 305 and 310 of method 300, identification information is obtained for a first business account and a second business account, respectively. The account data may be obtained from already existing, in-house databases of the enterprise which employs the present invention. In many cases, however, the business account data may be culled from business, government, and other databases which are external to the enterprise. Such external sources may include, for example and without limitation, Dun & Bradstreet of Short Hills, N.J., Donnelley Marketing of Woodcliff Lake, N.J., American Business Institute of Richmond, Calif., and numerous other business data sources well known in the art.

The type of data which may be obtained for a business account includes, for example and without limitation, a business name, a business owner identification, a business executive identification, a business staff person identification, a business address, a business phone number, a business type, a business service, a business product, a business communication channel, business financial data, business market data, the American Business Institute (ABI) identification number, a business identification number (BIN) assigned by Acxiom, a DUNS number assigned by Dun & Bradstreet, an executive home address provided by Dun & Bradstreet, an Execureach business record file which may be obtained from Donnelley Marketing, National Business Database (NBD) data provided by Experian, Federal Employee Identification Numbers (FEIN), other identification numbers well-known in the art, any commercially available data about the business, any government supplied data about the business, and data about the business which may be stored in an historical file of business prospects.

In step 315 name and address data for the business account data is standardized to ensure consistency across all business account data. Step 315 may involve extracting name and address data from both records, and possibly comparing the name and address data to other business account records which are on file. For example, it may be recognized that a “Charles J. Smith” and a “Charles John Smith” which show up in the two separate business accounts are both “Charles John Smith”, and the name may then be standardized to “Charles John Smith” in both business accounts. Similarly, street name, state name, and other abbreviations may be standardized so that, for example, “Jr.” becomes “Junior”, “Sr.” becomes “Senior”, “NY, N.Y.” becomes “New York, N.Y.”, etc. Persons skilled in the art will recognize that the examples provided here are exemplary only. Many forms of identification standardization, pertaining to many different types of identification data and varied formatting or standardization choices, may be implemented within the scope and spirit of the present invention.

In step 320, a series of matching rules are applied to the identification information for the first and second business accounts. Step 320 may be seen as having two distinct implementations 320a and 320b, which may however work jointly or interactively in some instances.

In step 320a, the business matching rules are applied to match an orphaned business account with an assigned business account. For example, it may be possible to match an orphaned business account record with an assigned business account record by applying a business matching rule which compares the EHA DUNs number of both business accounts, and determines there is a match if the two business accounts share the same EHA DUNs number. Similarly, it may be possible to match an orphaned business account record with an assigned business account record by applying a business matching rule which compares the phone number and business name, or the phone number and street name, of both business accounts, and determines that there is a match if the two business accounts share a common phone number and business name, or share a common phone number and street name. Other business matching rules are listed below.

In step 325, the two matched accounts are linked, indicating that they are both part of the same common business, by assigning to the orphaned account the common identifier, i.e., the value of the Site BIN 160, which is already in place for the assigned account.

Returning to step 320b, the business matching rules are applied to match a first orphaned business account with a second orphaned business account. Similar business matching rules may be applied to the two orphaned business accounts as those business matching rules described above, and to those listed below. However, since neither of the two business accounts has an assigned Site BIN number 160, a determination may need to be made in step 320c as to whether an existing value for a Site BIN number 160 should be applied, or whether instead a new value for a Site BIN number 160 should be created.

In one embodiment of the present invention, this may entail returning to step 310, obtaining another business account which is an assigned business account (i.e., an account for which a Site BIN 160 has already been assigned), and applying the business matching rules 320a to determine if the assigned business record matches either of the two previously obtained orphaned business records. If a match is found, then a determination has been made that both of the first and second previously obtained, orphaned business accounts match the assigned business account. In this case, in step 325, the value for the Site BIN number 160 of the assigned business account can now be assigned to the two orphaned business accounts. As a result, all three business accounts now share a commonly assigned value for Site BIN number 160, indicating that all three accounts are part of the same common business.

If a match is not found between either of the two matched-but-orphaned business accounts and an assigned business account, then in step 325 a new, unique Site BIN number 160 may be generated. As indicated above, the new, unique Site BIN number 160 may either be an entirely original identifier, or may be the same as some other identifier number of one of the two matched-but-orphaned business accounts. This new, unique value for the Site BIN number 160 is assigned to both of the matched business accounts, and links both business accounts as belonging to the same common business. At this point, having been assigned a common value for Site BIN number 160, both business accounts are no longer orphaned, but are instead assigned business accounts which are linked to each other via the shared value of the Site BIN number 160.

In an alternative embodiment, if two orphaned business accounts are found to match each other, a provisional or interim value for Site BIN 160 may be assigned in step 325 to link both business accounts, indicating they are both associated with a single common business. In the course of further processing, it may be found that the two linked business accounts are not matched with any other business accounts. In that event, the provisional or interim value for Site BIN 160 becomes established as the permanent Site BIN 160 for the two accounts. On the other hand, in the course of further processing, it may be found that both linked business accounts should be matched with a third business account which already has a different, conflicting Site BIN 160. Since all three matched accounts are to be associated as being part of a single business by virtue of having a shared, unique Site BIN value, one of the conflicting Site BIN values 160 will be retained and the other conflicting value removed.

Persons skilled in the relevant arts will recognize that a variety of algorithms may be employed to determine which of the two conflicting Site BIN values 160 will be retained. For example, once a priority has been established among the business records, as discussed further below, the Site BIN value 160 associated with the highest priority business record may be assigned to all the matched business records.

In step 330, hierarchy rules may be applied to the business accounts in order to determine which of the matched business accounts are to have a higher priority for marketing or other business contact purposes. Step 330 may be implemented by applying four different kinds of priority rules. In step 330a, a business account priority may be determined based on the data source of a business account record. In step 330b, a business account priority may be determined based on the business structure type of a business account. In step 330c, a set of hierarchy rules may be applied to determine an ultimate location. In step 330d, a set of hierarchy rules may be applied to determine a priority among contact persons.

Further details of business account matching rules and business account priority rules are presented below. It will be understood by persons skilled in the relevant arts that the manner of applying these rules, as presented above, is exemplary only. In particular, the order or manner in which business account records may be selected for matching, for comparison, or for prioritization, as described above, is exemplary only. Other algorithms may be employed within the spirit and scope of the present invention to apply, to a collection of business accounts, the business matching rules and business prioritization rules described further below.

### IV. Matching Rules

A variety of rules may be employed to match two business accounts, as indicated in steps 320, 320a, 320b, and 320c of method 300. Some of these rules may depend on data obtained from a variety of business-related data sources. Exemplary business-related data sources are included in the discussion below. The following list provides some definitions which may be helpful in interpreting the exemplary business matching rules provided further below:
ABI: American Business Institute, business record file provided by Donnelley Marketing
ABI #: Business identifier
BIN: Business Identification Number; unique identifier for each business name/address combination, assigned by Acxiom Corp. of Little Rock, Ark.
DMI: Business record file provided by Dun & Bradstreet
DUNS #: Dun & Bradstreet assigned business identifier
EHA: Executive Home Address; business record file provided by Dun & Bradstreet
Execureach: Business record file provided by Donnelley Marketing
Inductis, Inc. of New Providence, N.J.: a consulting firm
NBD: National Business Database, business record file provided by Experian Information Solutions of Costa Mesa, Calif.

Listed below are exemplary rules which may be used to match two business accounts, i.e., to determine that two business accounts are in fact associated with a single common business:

1. Assign Site BIN to DMI population, joining on DUNS Number.

2. Link records from the orphan population to assigned Site BIN using EHA DUNs number.

3. Link records from the orphan population to assigned Site BINs using Federal Employee Identification Number (FEIN).

4. Link records from the orphan population to assigned Site BINs using DUNs # from historical prospect file.

5. Link records from the orphan population to the assigned Site BINs using ABI number.

6. Link records from the orphan population to the assigned Site BINs using the Execureach ABI number.

7. Link records from the orphan population to the assigned Site BINs using Experian BIN from the NBD file.

8. Link records from the orphan population to the assigned Site BINs using match key created by the enterprise employing the present invention.

9. Link records from the orphan population to the assigned Site BINs by linking original BIN in the orphan population to the updated BIN in the assigned Site BIN population.

10. Link records from the orphan population to the assigned Site BINs using updated BIN in both the orphan and Site BIN population.

11. Link records from the orphan population to the assigned Site BINs using a combination of phone number and business name, or phone number and street name.

12. Link records from the orphan population to the assigned Site BINs using DUNs number applied to historical files by Inductis; comparing to both DMI and EHA DUNs numbers.

13. Link records from the orphan population to the assigned Site BINs using ABI number applied to historical files by Inductis; comparing to ABI and Execureach.

14. Assign Site BINs within remaining orphan population using EHA DUNs number.

15. Assign Site BINs within remaining orphan population using ABI number.

16. Assign Site BINs within remaining orphan population using Execureach ABI number.

17. Assign Site BINs within remaining orphan population using enterprise created match key.

18. Assign Site BINs within remaining orphan population using updated BINs.

19. Assign Site BINs within remaining orphan population using phone number and business name, or phone number and street name.

20. Assign Site BINs within remaining orphan population using DUNS # applied to historical files by Inductis.

21. Assign Site BINs within remaining orphan population using ABI # applied to historical files by Inductis.

22. Assign Site BINs within orphan population using ABI # applied to historical files by Inductis.

Persons skilled in the relevant arts will recognize that the above listed matching rules are exemplary only, and that other business matching rules or alternative business matching rules may be employed within the scope and spirit of the present invention.

### V. Hierarchy Rules

Hierarchy rules determine a higher or lower priority or priorities among two or more business accounts which are all matched with each other, that is, which are all associated with a common business. Below are exemplary rules for determining a hierarchical relationship among matched business accounts, that is, for setting higher and lower priorities among business accounts which are associated with a common business, as per steps 330, 330a, 330b, 330c, and 330d of method 300:

1. Data Source for Business Structure: A hierarchy rule may be based on the degree or extensiveness of information coverage from two or more data providers, for example, from Dun & Bradstreet and Donnelley Marketing. A determination may be made as to which sources list a given business account, or how many data sources list a given business account, or both. For example, a higher priority may be assigned to a business account which is listed by both Dun & Bradstreet and Donnelley Marketing; a lower priority may be assigned to a business account listed by only one of Dun & Bradstreet or Donnelley Marketing; and a lowest priority may be assigned to a business account which is not listed by either of Dun & Bradstreet and Donnelley Marketing. Priorities may also be assigned to specific business sources; for example, a business account listed only in Dun & Bradstreet may be assigned a higher priority than a business account listed only in Donnelley Marketing.

2. Business Structure Type: Various sources of business information, such as Dun & Bradstreet or Donnelley Marketing, provide site-specific business type information. Rules for establishing a hierarchy among business records associated with a common business may determine, for example, whether a site-level record is single-site or multi-site business. For example, the individual pizza shops of a pizza franchise may each be considered a single-site business. On the other hand, the corporate headquarters of the same pizza franchise, while itself located at a single site or location, none-the-less provides the executive leadership for the plurality of individual pizza shops in the franchise, and is therefore viewed as a multi-site business. A multi-site business account may be assigned a higher priority than a single-site business account of the same business. If the information from two data sources is conflicting (e.g., if the information from Dun & Bradstreet and Donnelley Marketing appear to be in conflict), the rule may prioritize one source over another.

3. Ultimate Location: By combining business structure information culled from a variety of sources with the common Site BINS (determined as describe above), it may be possible to determine which site-level record represents the ultimate site (i.e. the site that has the highest business management/operation hierarchy) and which site-level record(s) represent reporting site(s) (i.e. the site that reports to ultimate site in terms of business management/operation hierarchy). In this way, an enterprise may identify the ultimate location of a business, and its reporting locations. Typically, the ultimate location is assigned a higher priority, but there may be cases where reporting locations are assigned a higher priority.

4. Contact Persons: Records associated with a common business may also be prioritized in terms of a contact person associated with the business (not illustrated in FIG. 1 or FIG. 2). Rules concerning the priority of contact persons may be based on job titles which are culled from external data sources, and which are associated with the contact person. For example, a corporate chief executive officer (CEO) may be assigned a higher priority than a corporate chief financial officer (CFO). Multiple priorities may also be assigned, depending on a type of marketing campaign. For example, a financial enterprise which intends to primarily market financial instruments may assign a higher priority to a corporate CFO than to a corporate CEO.

Rules concerning the priority of contact persons may also be based on the frequency with which the name of a contact person appears in different external databases. Rules concerning the priority of contact persons may also be based in part on the other prioritization rules listed immediately above. For example, a contact person at the ultimate location may be considered a higher priority than a contact person at a reporting location.

Persons skilled in the relevant arts will recognize that the above listed hierarchy rules are exemplary only, and that other hierarchy rules or alternative hierarchy rules may be employed within the scope and spirit of the present invention.

### VI. High-Level View of i-CLIC Method

FIG. 4 is a flowchart 400 illustrating an exemplary institutional customer linking and identification capability (i-CLIC) process according to one embodiment of the present invention. The flowchart illustrates the process at an aggregate level of processing, and includes the connection of the exemplary i-CLIC process with a business marketing process. The flow chart may be viewed as a high-level view of an i-CLIC process, in conjunction with related business processes. FIG. 4 may also be understood, in part, as a hybrid illustration, since the flowchart includes some system elements along with process elements.

In step 410, business account data, which may contain multiple business account records, is obtained from source input files 410a, most of which may come from external sources, but which may also come from data warehouse 430a. The format is standardized, and name and address links may be determined between business records. The determination of name and address links may be viewed as a pre-processing which may facilitate application of some of the business matching rules in step 420. Step 410 may correspond to steps 305, 310, and 315 of process 300 shown in FIG. 3.

In step 415, a contact cross-reference table or database 415a, which may be used to implement the present invention, may be updated with the account data which has been newly imported and processed in step 410.

In step 420, business matching rules are applied to the business accounts in the contact cross reference table 415a, in order to link multiple business accounts for the same business. Step 420 may correspond to steps 320, 320a, 320b, 320c, and 325 of process 300 shown in FIG. 3. The result is that multiple contacts (e.g., business records with different contact information) belonging to the same business are now linked, and also that multiple addresses belonging to the same business (e.g., business records representing different operating locations of the same business) are linked as well.

In step 425, business hierarchy rules are applied to the business accounts in the contact cross reference table 415a. While method 300 of FIG. 3 illustrated the application of business hierarchy rules 330 as following the application of business matching and linking rules 320, 325, process 400 of FIG. 4 shows that determining business account hierarchy may in some cases be performed partly or wholly in parallel with determining the matching of business accounts. Step 425 may correspond to steps 330, 330a, 330b, 330c, and 330d of process 300 shown in FIG. 3.

In step 430, the business account data, which is now linked and prioritized, is stored in a data warehouse 430a, which may comprise one or more enterprise-oriented databases. It should be noted that the data stored in data warehouse 430a may be part of the input data 410a which is used when the entire linking and prioritization process may be run again on a future occasion.

In step 435, a marketing data build may be performed to extract data from data warehouse 430a. The data so extracted may be selected based on the needs of a particular marketing campaign. Because business accounts belonging to a common business have been linked and may have been prioritized as well, marketing data build 435 may achieve the following:
It is possible to reduce unintentional solicitations to the same business, because separate business accounts which are actually part of the same business have been identified.
Prospect (i.e., marketing campaign target) wishes can be honored more thoroughly. For example, if a prospect (e.g., a particular business) has opted out of a particular kind of solicitation, then all the business accounts associated with that business can be eliminated from further solicitations of the kind in question.
Enterprise direct marketing policies can be applied more effectively. For instance, if a decision is made not to solicit a particular business because it is already a customer, then all the business accounts associated with that business can be removed from the solicitations.
Priorities can be established regarding which accounts of a business should actually be targeted for the marketing campaign.

Finally, in step 440, the marketing campaign is executed in accordance with business customer wishes and enterprise policies, as implemented in conjunction with the optimized (i.e., linked and prioritized) business accounts records maintained by the enterprise.

### VII. Exemplary System

The present invention, as typically embodied in a in method 300 or method 400, or as implemented in alternate embodiments as suggested throughout this detailed section and the appended claims, or any part(s) or function(s) thereof, may be implemented using hardware, software, and human operator decision making, or a combination thereof and may be implemented in part or in whole by one or more computer systems or other processing systems. However, the manipulations performed by the present invention were often referred to in terms, such as analyzing, comparing, linking, matching, or prioritizing, which are commonly associated with mental operations performed by a human operator.

While the intervention of a human operator may play a role in validity checking of, auditing of, or modification of the business account linkages and business account hierarchies established in the present invention, such intervention of a human operator is only necessary in some embodiments of the present invention and not others. In most cases, most and possibly all of the operations described herein which form part of the present invention are performed without the intervention of a human operator. Rather, the operations are machine operations. Useful machines for performing the operation of the present invention include general purpose digital computers or similar devices.

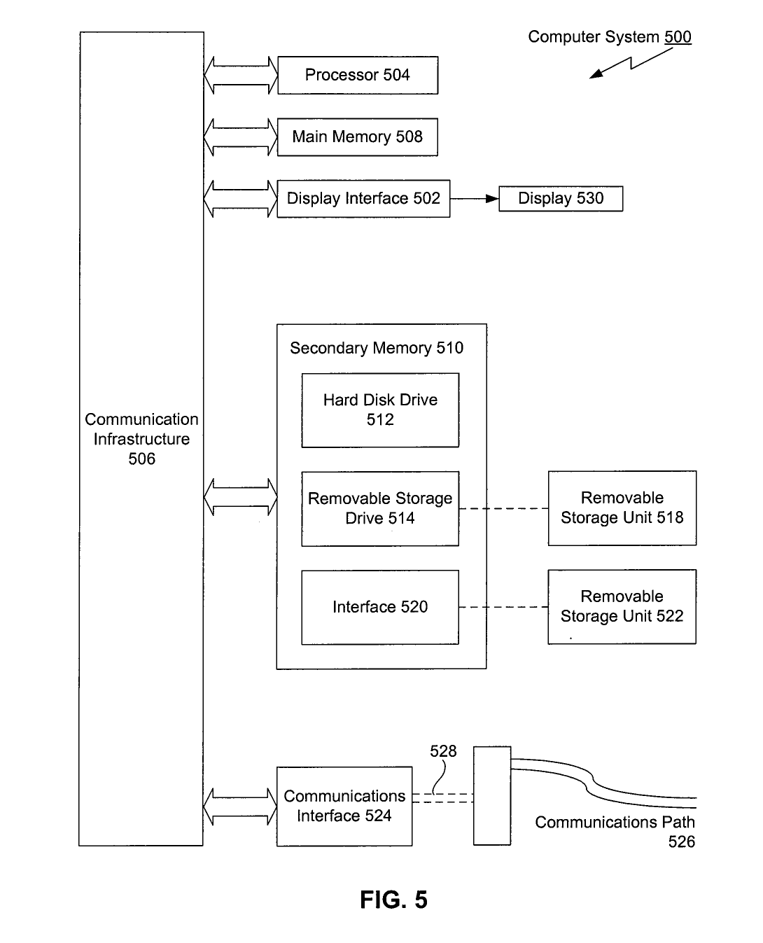

In one embodiment, the invention is directed toward one or more computer systems capable of carrying out the functionality described herein. An example of a computer system 500 is shown in FIG. 5.

The computer system 500 includes one or more processors, such as processor 504. The processor 504 is connected to a communication infrastructure 506 (e.g., a communications bus, cross-over bar, or network). Various software embodiments are described in terms of this exemplary computer system. After reading this description, it will become apparent to a person skilled in the relevant art(s) how to implement the invention using other computer systems and/or architectures.

Computer system 500 can include a display interface 502 that forwards graphics, text, and other data from the communication infrastructure 506 (or from a frame buffer not shown) for display on the display unit 530.

Computer system 500 also includes a main memory 508, preferably random access memory (RAM), and may also include a secondary memory 510. The secondary memory 510 may include, for example, a hard disk drive 512 and/or a removable storage drive 514, representing a floppy disk drive, a magnetic tape drive, an optical disk drive, etc. The removable storage drive 514 reads from and/or writes to a removable storage unit 518 in a well known manner. Removable storage unit 518 represents a floppy disk, magnetic tape, optical disk, etc. which is read by and written to by removable storage drive 514. As will be appreciated, the removable storage unit 518 includes a computer usable storage medium having stored therein computer software and/or data.

In alternative embodiments, secondary memory 510 may include other similar devices for allowing computer programs or other instructions to be loaded into computer system 500. Such devices may include, for example, a removable storage unit 522 and an interface 520. Examples of such may include a program cartridge and cartridge interface (such as that found in video game devices), a removable memory chip (such as an erasable programmable read only memory (EPROM), or programmable read only memory (PROM)) and associated socket, and other removable storage units 522 and interfaces 520, which allow software and data to be transferred from the removable storage unit 522 to computer system 500.

Computer system 500 may also include a communications interface 524. Communications interface 524 allows software and data to be transferred between computer system 500 and external devices. Examples of communications interface 524 may include a modem, a network interface (such as an Ethernet card), a communications port, a Personal Computer Memory Card International Association (PCMCIA) slot and card, etc. Software and data transferred via communications interface 524 are in the form of signals 528 which may be electronic, electromagnetic, optical or other signals capable of being received by communications interface 524. These signals 528 are provided to communications interface 524 via a communications path (e.g., channel) 526. This channel 526 carries signals 528 and may be implemented using wire or cable, fiber optics, a telephone line, a cellular link, an radio frequency (RF) link and other communications channels.

In this document, the terms “computer program medium” and “computer usable medium” are used to generally refer to media such as removable storage drive 514, a hard disk installed in hard disk drive 512, and signals 528. These computer program products provide software to computer system 500. An embodiment of the invention is directed to such computer program products.

Computer programs (also referred to as computer control logic) are stored in main memory 508 and/or secondary memory 510. Computer programs may also be received via communications interface 524. Such computer programs, when executed, enable the computer system 500 to perform the features of the present invention, as discussed herein. In particular, the computer programs, when executed, enable the processor 504 to perform the features of the present invention. Accordingly, such computer programs represent controllers of the computer system 500.

In an embodiment where the invention is implemented using software, the software may be stored in a computer program product and loaded into computer system 500 using removable storage drive 514, hard drive 512 or communications interface 524. The control logic (software), when executed by the processor 504, causes the processor 504 to perform the functions of the invention as described herein.

In another embodiment, the invention is implemented primarily in hardware using, for example, hardware components such as application specific integrated circuits (ASICs). Implementation of the hardware state machine so as to perform the functions described herein will be apparent to persons skilled in the relevant art(s).

In yet another embodiment, the invention is implemented using a combination of both hardware and software.

### VI. CONCLUSION

While various embodiments of the present invention have been described above, it should be understood that they have been presented by way of example, and not limitation. It will be apparent to persons skilled in the relevant art(s) that various changes in form and detail can be made therein without departing from the spirit and scope of the present invention. Thus, the present invention should not be limited by any of the above described exemplary embodiments, but should be defined only in accordance with the following claims and their equivalents.

In addition, it should be understood that the figures and screen shots illustrated in the attachments, which highlight the functionality and advantages of the present invention, are presented for example purposes only. The architecture of the present invention is sufficiently flexible and configurable, such that it may be utilized (and navigated) in ways other than that shown in the accompanying figures.

Further, the purpose of the foregoing Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present invention in any way.

What is claimed is:

1. A method comprising:
identifying, by a computer system, a first collection of data records on a first database;
identifying, by the computer system, a second collection of data records on a second database, wherein the first collection of data records is not linked to the second collection of data records;
determining, by the computer system, that the first collection of data records and the second collection of data records are associated with the same business entity, wherein the determining is based on application of business matching rules to the first collection of data records and the second collection of data records;
merging, by the computer system, the first collection of data records and the second collection of data records to a single database; and
assigning, by the computer system, to the first collection of data records and the second collection of data records a common identifier in response to the determining, wherein the common identifier creates a link between the first collection of data records and the second collection of data records on the consolidated database.
